(19) United States
(12) Patent Application Publication
(10) Pub. No.: US 2007/0101576 A1
(43) Pub. Date: May 10, 2007

(54) Blunt tip utility blade

(75) Inventor: Matthew C. Green, Amherst, MA (US)

Correspondence Address: MCCARTER & ENGLISH LLP;CITYPLACE I, 185 ASYLUM STREET, HARTFORD, CT, 06103, US

(73) Assignee: Irwin Industrial Tool Company

(21) Appl. No.: 11/595,072

(22) Filed: Nov. 10, 2006

Related U.S. Application Data
(60) Provisional application No. 60/736,013, filed on Nov. 10, 2005.

(51) Int. Cl. B26B 21/14

(52) U.S. Cl. 30/62

(57) ABSTRACT

A utility blade comprises a blade body having a generally planar shape defined by a cutting edge, an opposite back edge and a pair of opposing side edges. The pair of opposing side edges includes at least one first side edge having a first end and a second end. The first end of the at least one first side edge extends substantially normal to the cutting edge from a terminal end defining the cutting edge. A convex radiused edge extends from the second end of the at least one first side edge. The convex radiused edge provides a substantially blunt profile configured to limit puncture wounds to a user, and the at least one first side edge intersecting with the cutting edge provides a sharp profile for penetration through an object.

### CROSS-REFERENCE TO RELATED APPLICATIONS

This application claims priority to U.S. Provisional Application No. 60/736,013, filed Nov. 10, 2005, the contents of which are hereby expressly incorporated by reference as part of the present disclosure.

### BACKGROUND

The present invention relates to utility knife blades, and more particularly, to safety utility knife blades having an exposed side edge which reduces the risk of inadvertent injury to the user while providing suitable penetration through a work piece.

Utility knives having disposable blades are well known in the art. These knives have many industrial as well as home uses, such as for opening boxes, cutting cord, or carving wall board or wood. A typical utility knife has a plastic or metal handle with a retractable blade. When not in use, the blade is retracted into the body of the handle so that the knife can be safely stored or handled. When in use, the blade can extend outwardly from the handle, exposing the cutting edge of the blade.

Utility knife blades come in a variety of shapes, depending upon the intended use. As partially shown with reference to FIG. 1, a typical form of blade has a generally trapezoidal shape, with a wide cutting edge. The two side edges (only one shown) converge from the outer ends of the blade toward a narrower back edge. The side edges and the back edge are blunted. The blade may additionally have an aperture pattern through a center portion of the blade which enables the blade to be secured within the handle. The trapezodial shape blades are popular since they have pointed cutting corners formed at the intersections between the side edges and the cutting edge. These cutting corners form an acute angle by intersection of the side edges with the cutting edge and enable a user to puncture through a material which is desired to be cut, such as sealing tape closing a box or the cardboard defining the box. Once the object has been punctured, the user can slice open the material by dragging the knife along the surface of the material and allowing the cutting edge to pull through the material.

Although blades having acute angle cutting corners may be preferred for the reasons described above, the acute angle cutting corner can cause injury to a user. For example, the blade can cause inadvertent injury when being used, such as by the cutting corner puncturing the skin of the operator. In addition, care must be taken when loading a fresh blade into the holder, in order to reduce the risk of receiving a puncture wound as a result of contact with the cutting corner. The user must hold the blade by contacting only the broad surfaces of the blade, such as between the thumb and forefinger.

FIG. 2 illustrates a utility blade with a rounded point that effectively removes the possibility of accidental puncture wounds. In practice, some users do not like the rounded cutting corner blades because they do not penetrate the work piece very well. For example, the rounded point is less efficient as a box cutter. Many users will remove the “safety” rounded point blades and replace them with sharp point blades that they feel are more functional. However, this often violates applicable safety policies. Thus, although the blade of FIG. 2 reduces the threat of injury to a user, it is less efficient in puncturing a work piece because of the rounded tips.

FIG. 3 illustrates a utility blade formed with obtuse angle cutting corners while FIG. 4 illustrates a utility blade formed with right angle cutting corners. The utility blade of FIG. 3 is the subject of U.S. Pat. No. 5,337,482 to Schmidt. Each of FIGS. 3 and 4 define the respective cutting edge corners via a side edge having a first end extending from the cutting edge, and a second end intersecting a major side edge and thereby forming an outboard pointed end. FIGS. 3 and 4 represent utility blades having cutting corners that are better suited to penetrate a work piece than the utility blade of FIG. 2, but are not as effective at reducing the risk of puncture wounds to a user because of the exposed pointed end on each outboard side edge of the blade.

It is an object of the present invention to overcome one or more of the above-described drawbacks and/or disadvantages of prior art utility knife blades.

### SUMMARY OF THE INVENTION

The present invention is directed to a blade for a utility knife having blunt side edges to prevent injury, but while still having a cutting corner for puncturing workpieces, such as for box cutting. In accordance with one aspect of the present invention, a utility blade includes a blade body of a generally planar shape, a cutting edge, a back edge opposite the cutting edge, and a pair of opposing side edges. At least one first side edge includes a first end and a second end. The first end of the first side edge extends substantially normal to the cutting edge from a terminal end defining the cutting edge, and a convex radiused edge extends from the second end of the first side edge. The convex radiused edge provides a substantially blunt profile configured to limit puncture wounds to a user, while the first end of the first side edge intersects the cutting edge at approximately 90° to thereby provide a sharp profile for penetration through an object.

In accordance with another aspect of the present invention, a utility blade includes a trapezoidal blade body of a generally planar shape and having at least one notch enabling engagement with a handle configured to receive the blade body, a cutting edge, a blunt back edge, and a pair of opposing side edges. Each side edge includes a first side edge having a first end and a second end. The first end of each first side edge extends substantially normal to the cutting edge at opposing terminal ends defining the cutting edge. A pair of opposing convex radiused edges each extend from the second end of a respective first side edge and has a radius of about ¼ inch. The intersection of each first side edge with the cutting edge defines a substantially right angle cutting corner. Each cutting corner is substantially laterally aligned with a corresponding convex radiused edge, such that each convex radiused edge provides a substantially blunt profile configured to limit puncture wounds to a user while the corresponding cutting corner provides a sharp profile to facilitate penetration through an object.

In accordance with yet another aspect of the present invention, a utility knife includes a blade body of a generally planar shape, a cutting edge and a pair of opposing side edges. At least one first side edge of the pair of opposing side edges includes a first end and a second end. The first end of the at least one first side edge extends substantially normal to the cutting edge from a terminal end defining the cutting edge. A convex radiused edge extends from the second end of the at least one first side edge. A handle is configured to receive the blade body, wherein the at least one first side edge and at least a portion of said cutting edge are exposed during use. The convex radiused edge provides a substantially blunt profile configured to limit puncture wounds to a user, and the first end of the first side edge provides a sharp profile for facilitating penetration through an object.

One advantage of the utility blades of the present invention is that at least one corner region of the cutting edge includes a first portion formed at the intersection of the side edge and cutting edge that is substantially perpendicular to the side edge to thereby form a sharp profile that facilitates piercing an object. The corner region also includes a second portion located on an opposite end of the corner region relative to the first portion and defining a convex radiused edge, to thereby provide the corner region with a blunt lateral profile that prevents a user from being inadvertently injured by the corner region as encountered in the above-described prior art utility blades.

Other objects and advantages of the present invention will become more readily apparent in view of the following detailed description of preferred embodiments and accompanying drawings.

### BRIEF DESCRIPTION OF THE DRAWINGS

FIG. 1 is a partial, side elevational view of a prior art trapezoidal utility blade;

FIG. 2 is partial, side elevational of a prior art rounded tip utility blade;

FIG. 3 is a partial, side elevational view of a prior art utility blade having a cutting edge that intersects opposing side edges at an obtuse angle;

FIG. 4 is a partial, side elevational view of a prior art utility blade having a cutting edge that intersects opposing side edges at a right angle;

FIG. 5 is a side elevational view of a first embodiment of a utility blade of the present invention having a cutting edge that intersects opposing side edges at respective first ends at a substantially right angle, while respective second ends of the side edges define a convex radiused portion that intersects a major side edge of the blade;

FIG. 6 is a partial, enlarged view of a corner region of the utility blade of FIG. 5;

FIG. 7 is a front elevational view of the utility blade of FIG. 5;

FIG. 8 is an enlarged view of a corner region of the utility blade of FIG. 7; and

FIG. 9 is a side elevational view of the utility blade of FIG. 5 used in conjunction with a utility knife handle.

FIG. 10 is a side elevational view of a second embodiment of a utility blade of the present invention that is usable in the utility knife handle of FIG. 9 and that includes four notches in the back edge of the blade to provide two cutting positions on the blade carrier of the handle for each side of the cutting edge of the blade.

FIG. 11 is a partial, side elevational view of a third embodiment of a utility blade of the present invention wherein the blade includes a plurality of cutting edge segments separated by score lines to allow each worn exposed cutting edge to be manually engaged, snapped off and discarded, and thereby expose a fresh cutting edge segment for use, and wherein the exposed corner edge of each cutting edge segment is defined by a cutting edge intersecting a side edge at a first end forming a right angle, while a second end of the side edge defines a convex radiused portion that intersects a major side edge of the blade.

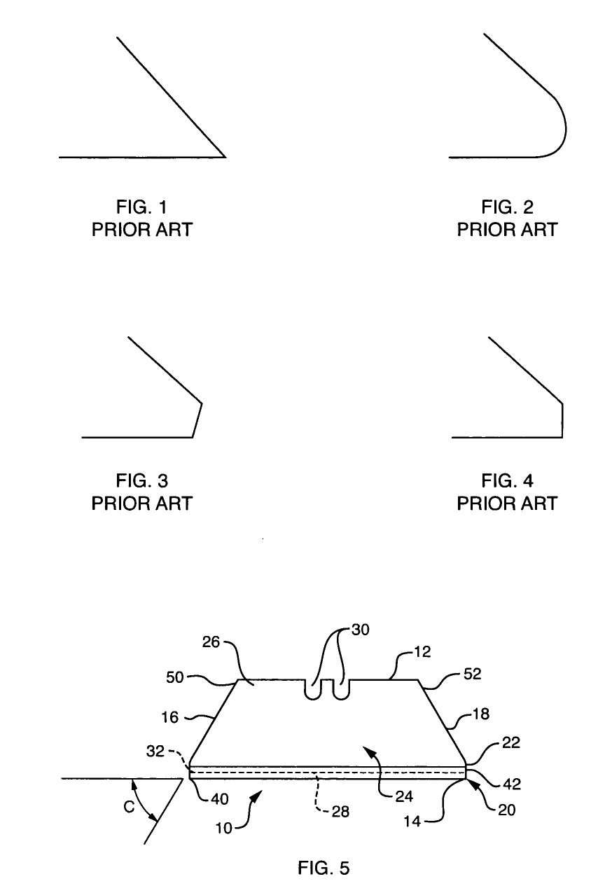

### DETAILED DESCRIPTION OF THE PREFERRED EMBODIMENTS

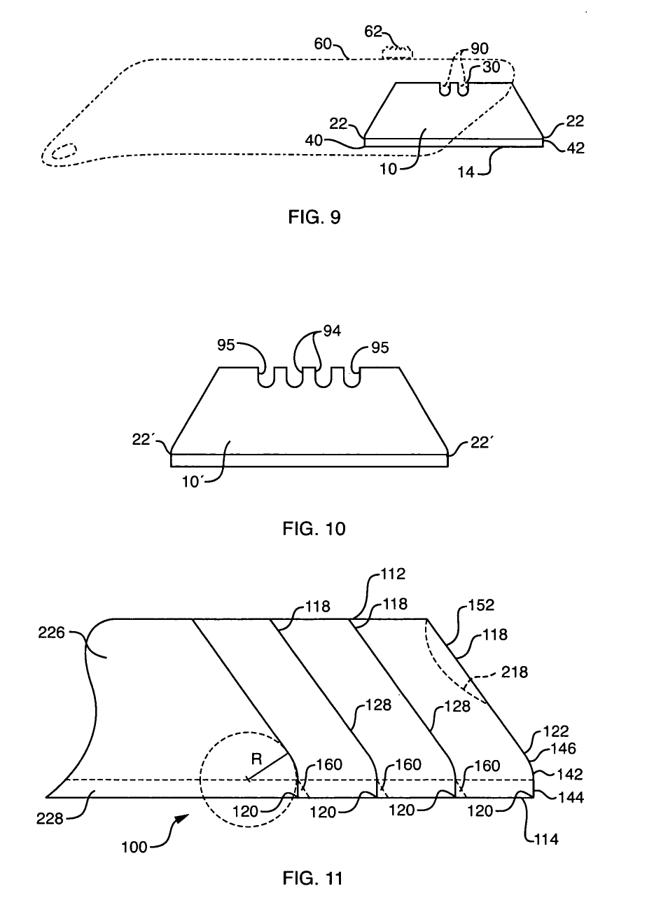

In FIG. 5, a blunt tip utility knife blade embodying the present invention is indicated generally by the reference numeral 10. The utility knife blade 10 defines a back edge 12, a cutting edge 14 located on an opposite side of the blade relative to the back edge, and two side edges 16, 18 located on opposite sides of the blade relative to each other and extending between the back and cutting edges of the blade. As shown typically in FIG. 5, in the currently preferred embodiment of the present invention, the back, cutting and side edges of the blade preferably define an approximately trapezoidal peripheral configuration. However, as described further below with reference to FIG. 9, for example, the utility knife blade of the present may take any of numerous different shapes or configurations that are currently known or later become known, including, for example, a square or parallelogram shape.

In the exemplary embodiment of FIG. 5, the blade 10 is a bi-metal blade defining a blade body 24 including a first metal portion 26 and a second metal portion 28. The first metal portion 26 extends between the back edge 12 and the second metal portion 28, and further extends from approximately one side edge 16 to the other side edge 18. In the illustrated embodiment, the first metal portion 26 is formed of a steel, typically referred to as an “alloy” steel, that is heat treated to a surface hardness within the range of approximately 38 Rockwell “c” (referred to herein as “Rc”) to approximately 52 Rc. The second metal portion 28 defines the cutting edge 14 and extends from approximately one side edge 16 to the other side edge 18. In accordance with the present invention, the second metal portion 28 is formed of a steel, typically referred to as a “high speed” or “tool” steel, that is heat treated to a surface hardness within the range of approximately 60 Rc to approximately 75 Rc.

The first metal portion 26 defines a spring-like backing that is relatively pliable, tough, and thus highly resistant to fatigue and cracking. The second metal portion 28, on the other hand, is relatively hard and highly wear resistant, and thus defines an ideal, long-lasting cutting blade. As a result, the composite utility knife blades define highly wear-resistant, long-lasting cutting edges, combined with virtually unbreakable or shatter-proof backings.

The first metal portion 26 of blade 10 is preferably made of any of numerous different grades of steel capable of being heat treated to a surface hardness within the range of approximately 38 Rc to approximately 52 Rc, such as any of numerous different alloy steels or standard AISI grades, including without limitation 6135, 6150 and D6A. The second metal portion 28, on the other hand, is preferably made of any of numerous different types of wear-resistant steel capable of being heat treated to a surface hardness within the range of approximately 60 Rc to approximately 75 Rc, including any of numerous different tool steels or high-speed steels, such as any of numerous different standard AISI grades, including, without limitation, M Series grades, such as M1, M2, M3, M42, etc., A Series grades, such as A2, A6, A7 A9, etc., H Series grades, such as H10, H11, H12, H13, etc., T Series grades, such as T1, T4, T8, etc., and W, S, O, D and P Series grades.

As further shown in FIG. 5, the blade 10 defines a weld region indicated generally with a dashed line 32 formed between the first and second metal portions 26 and 28, respectively, and defining an approximate line of joinder extending from one side edge 16 to the other side edge 18. The second metal portion 28 is joined to the first metal portion 26 by applying thermal energy to the interface, such as by electron beam welding, to thereby weld the first metal portion to the second metal portion and form a resulting weld region defining a line of joinder between the two different metal portions.

Further details of the composite utility blades and the manufacture of such blades are disclosed in the following patent and co-pending patent applications that are assigned to the assignee of the present invention and are hereby expressly incorporated by reference as part of the present disclosure: U.S. Pat. No. 6,701,627 issued Mar. 9, 2004, entitled “COMPOSITE UTILITY KNIFE BLADE AND METHOD OF MAKING SUCH A BLADE”; U.S. patent application Ser. No. 10/202,703 filed Jul. 24, 2002, entitled “Composite Utility Knife Blade and Method of Making Such a Blade”; and U.S. patent application Ser. No. 10/793,593 filed Mar. 4, 2004, entitled “COMPOSITE UTILITY BLADE AND METHOD OF MAKING SUCH A BLADE”.

As may be recognized by those skilled in the pertinent art based on the teachings herein, the currently preferred materials used to construct the first and second metal portions 26 and 28 and disclosed herein are only exemplary, and any of numerous other types of metals that are currently known or later become known for performing the functions of the first and/or second metal portions may be equally employed to form the composite utility knife blades. Alternatively, it will be recognized that the utility blades of the present invention need not define a bi-metal or other composite structure, but rather may be made with only a single metal substrate, such as with traditional carbon steel blades, and/or may include any of numerous different coatings to enhance cutting performance and/or wear characteristics, and/or for decorative purposes, including any of numerous different PVD coatings, such as TiN, AlTiN, other carbide-forming coatings, and combinations of the foregoing. Exemplary coatings and the application of such coatings to utility blades are disclosed in further detail in the following co-pending patent application that is assigned to the assignee of the present invention and is hereby expressly incorporated by reference as part of the present disclosure: U.S. patent application Ser. No. 10/793,593 filed Mar. 4, 2004, entitled “Composite Utility Knife Blade and Method of Making Such a Blade”.

As further shown in FIG. 5, each composite utility knife blade 10 defines a pair of cut outs or notches 30 formed in the back edge 12 and laterally spaced relative to each other. As shown typically in FIG. 5, each notch 30 defines a concave, approximately semi-circular profile, and is provided to engage a corresponding locator mounted within a blade holder (not shown) in order to retain the blade in the blade holder. As may be recognized by those skilled in the pertinent art based on the teachings herein, each notch 30 may take any of numerous different shapes and/or configurations and may be located in any of numerous different locations, and the blade may include any number of such notches or apertures or other recesses that are currently known or later become known to those skilled in the pertinent art for performing the function of engaging a blade holder, or the blade actuating mechanism or locator of such a holder.

As also shown in FIG. 5, the cutting edge 14 defines an approximately straight cutting edge extending from one side edge 16 to the other side edge 18. As shown in FIGS. 7 and 8, the cutting edge 14 preferably defines first facets 34 located on opposite sides of the blade relative to each other, and second facets 36 spaced laterally inwardly and contiguous to the respective first facets 34. As shown typically in FIG. 8, the first facets 34 define a first included angle “A”, and the second facets 36 define a second included angle “B”. Preferably, the second included angle B is greater than the first included angle A. In the currently preferred embodiment of the present invention, the first included angle A is approximately 14° and the second included angle B is approximately 10°. However, as may be recognized by those skilled in the pertinent art based on the teachings herein, these included angles are only exemplary, and may be set as desired depending upon the physical properties and/or proposed applications of the blade. As may be further recognized by those skilled in the pertinent art, the utility knife blades of the present invention may include any number of facets.

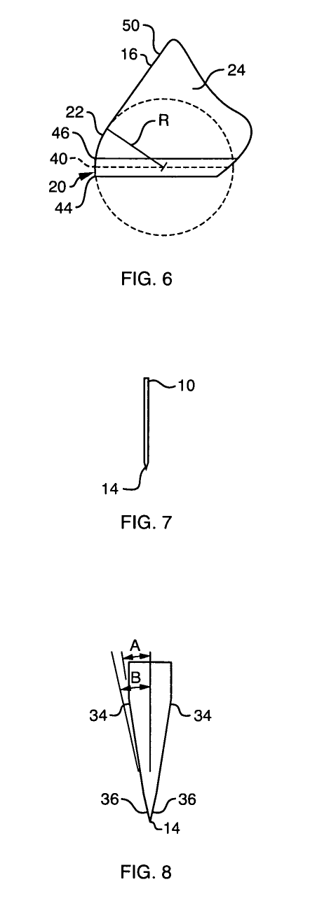

Referring now to FIGS. 5 and 6, side edges 16 and 18 each define a respective squared corner 20 and a convex radiused edge 22 extending from the squared corner 20. FIG. 6 is a partial enlarged view of the left side edge 16 of FIG. 5 illustrating the junction of the squared corner 20 with the respective convex radiused edge 22. Each squared corner 20 is defined by an intersection of the cutting edge 14 with a corresponding first side edge 40, 42. Each first side edge 40, 42 is defined by a first end 44 and an opposing second end 46. Each first end 44 is joined with a corresponding terminal end of the cutting edge 14 and is oriented substantially normal to the cutting edge. Each second end 46 is joined with the respective convex radiused edge 22 and also extends substantially normal to the cutting edge 14. Each first side edge 40, 42 forms a substantially right angle cutting corner with respect to the cutting edge 14. In this manner, the blade 10 includes opposing cutting corners 20 each configured to penetrate a work piece, while simultaneously presenting blunt lateral surfaces defined by the convex radiused edges 22 to prevent inadvertent injury to a user.

Each of the opposing convex radiused edges 22 extend from the respective first side edges 40, 42 and provide blunt edges which prevent or reduce the risk of puncture wounds to a user. It is contemplated that a bend radius “R” of each convex radiused edge 22 is between about ⅛ inch and about ⅜ inch. In an exemplary embodiment as shown in FIGS. 5 and 6, the radius R is about ¼ inch.

Each of the opposing convex radiused edges 22 includes one end extending from the respective first side edge 40 or 42 and another opposite end extending from a respective second side edge 50 or 52 that extends to the back edge 12. In this manner, the convex radiused edges 22 are intermediate the respective first side edges 40, 42 and second side edges 50, 52, respectively.

As shown typically in FIG. 5, in the illustrated embodiment of the present invention, the back, cutting and side edges of the blade define an approximately trapezoidal peripheral configuration. However, as described further below, as well as with reference to FIG. 9, for example, the utility knife blades of the present invention may take any of numerous different shapes or configurations that are currently known or later become known, including, for example, a square or parallelogram shape, and/or any desired shape having at least one substantially squared cutting corner and a convex radiused edge extending from the squared cutting corner.

In the exemplary embodiment as shown in FIG. 5, the second side edges 50 and 52 form an angle C relative to either the cutting or back edges. In the exemplary embodiment, the angle C is about 52°; however, other angles suitable to the desired end purpose are also contemplated. Although the second side edges 50, 52 have been described and shown as being straight edges, the second side edges 50, 52 alternatively may be curved or take a number of other shapes as each extends from a convex radiused edge 22 to the back edge 12.

FIG. 9 illustrates the blade 10 of FIG. 5 seated on a blade carrier of a utility knife handle 60 with the notches 30 of the blade engaging the blade-engaging bosses of the blade carrier. The utility knife handle 60 includes a manually engageable button 62 for moving the blade between extended and retracted positions relative to a blade aperture 68 defined by the handle 60. When the extended portion of the cutting edge 14 of the blade 10 becomes dull, the blade can be flipped over and the other half of the blade used. The blade 10 can be removed from the holder and held with the operator contacting either the side edges 16, 18, at the convex radiused edges 22 and/or the first side edges 40, 42 of the blade substantially without the risk of a puncture wound. As may be recognized by those of ordinary skill in the pertinent art based on the teachings herein, the utility blades of the present invention are usable with any of numerous different types of handles in blade carriers that are currently known, or that later become known, including for example any of numerous different types of retractable blade utility knife handles and fixed blade utility knife handles. Alternatively, the utility knife blades of the present invention can be designed for use without a handle, such as in a rectangular form similar in shape to that of a conventional safety razor or utility blade.

In FIG. 10, another embodiment of a utility blade of the present invention is indicated generally by the reference numeral 10′. The primary difference of the utility blade 10′ in comparison to the utility blade 10 described above, is that the utility blade 10′ defines in its upper edge two inner notches or u-shaped apertures 94 and two outer notches or u-shaped apertures 95. Accordingly, each side of the blade defines two cutting positions, a first cutting position with the blade-engaging bosses 90 received within the two inner notches 94, and a second cutting position with the blade-engaging bosses 90 received within one inner notch 94 and a respective outer notch 95. In the illustrated embodiment, when the blade 10′ is located in the first cutting position, about 45% of the cutting edge extends outwardly of the blade aperture 68 and is exposed for cutting in the fully-extended position of the carrier. In the second cutting position, on the other hand, a greater portion of the cutting edge extends outwardly of the blade aperture 68 in comparison to the first cutting position. In the illustrated embodiment, in the second cutting position, about 55% of the cutting edge extends outwardly of the blade aperture 38 and is exposed for cutting in the fully-extended position of the carrier. One advantage of the blunt tip utility blades of the present invention is that if the corner of the blade is not fully retractable within the handle, as can be the case when the blade 10′ is located in the second cutting position, the convex radiused edge 22′ can extend outwardly of the blade aperture of the handle substantially without risk of puncturing a user.

FIG. 11 illustrates a partial side elevational view of a blunt tip segmented utility knife blade in accordance with an alternative embodiment of the present invention and indicated generally by the reference numeral 100. The utility knife blade 100 defines a back edge 112, a cutting edge 114 located on an opposite side of the blade relative to the back edge, and two outboard side edges 118 (only the right side edge shown) located on opposite sides of the blade relative to each other and extending between the back and cutting edges of the blade. As partially shown typically in FIG. 11, in the illustrated embodiment, the back, cutting and side edges 114, 112, and 118, respectively, of each blade section resemble the corresponding cutting edge 14, back edge 12, and side edge 18 of the utility blade of FIG. 5

In particular, FIG. 11 illustrates a snap-off blade segment configuration in which the blade 100 includes a plurality of score lines 128, each defining the profile of a respective side edge 118. In this manner, when an outboard blade segment becomes unusable due to dulling or breakage, the outboard segment may be manually snapped off at a proximate score line 128 subsequently exposing a new side edge 118 having a new cutting corner 120 defined by the intersection of the cutting edge 114 and new side edge 118. The score lines 128 are axially spaced relative to each other on the blade and each extends from the cutting edge 114 to the back edge 112.

As with the side edge 18 described above with reference to FIGS. 5 and 6, the outboard side edge 118 and each of the plurality of score lines 128 are defined by a first side edge 142 having a first end 144 and an opposing second end 146, and a convex radiused edge 122 extending from the opposing second end 146 of the first side edge 142. Each first end 144 is joined with a corresponding terminal end of the cutting edge 114. The first side edge 142 extends substantially normal to the cutting edge 114 and is joined with a respective convex radiused edge 122. Each first side edge 142 substantially forms a right angle cutting corner with respect to the cutting edge 114. In this manner, the blade 100 provides a plurality of cutting corners 120 (only one exposed at a time) with each configured to penetrate a work piece.

Each of the exposed convex radiused edges 122 extending from the respective first side edges 142 provide blunt edges which prevent or reduce the risk of puncture wounds to a user. It is contemplated that a bend radius “R” of each convex radiused edge 122 is between about ¼ inch and about ⅜ inch. In the illustrated embodiment of FIG. 10, the radius R is about ¼ inch.

Each of the opposing convex radiused edges 122 include one end extending from the respective first side edge 142, and another opposite end extending from a respective second side edge 152 that extends to the back edge 112. In this manner, the convex radiused edges 122 are intermediate the respective first side edges 142 and second side edges 152.

As may be recognized by those skilled in the pertinent art based on the teachings herein, the utility blades 100 may be made of any of numerous different material that are currently known, or that later become known, such as conventional carbon steel, bi-metal or other composite constructions, and/or may include any of numerous different coatings, such as wear-resistant coatings and/or decorative coatings. In addition the scoring instrument used to provide the plurality of scoring lines 128 may take any of numerous different configurations that are currently known, or later that become known for performing the function of scoring the strip forming the utility blades, such as a carbon steel strip or a bi-metal or other composite strip as described above in the above-mentioned patent and co-pending patent applications. For example, a progressive die may be employed to form the score lines 128. The term score line is used herein to mean a line defined by a recess or indentation in the surface of the blade 100.

In accordance with a currently preferred embodiment of the present invention, the depth of score is within the range of about 40% to about 50% of the thickness of the blade, and most preferably within the range of about 45% to about 48% of the thickness of the blade. In the illustrated embodiment, the blade is approximately 0.6 mm thick, and the depth of score is within the range of about 0.27 mm to about 0.29 mm. Also in accordance with the currently preferred embodiment of the present invention, each score line is approximately v-shaped, and the included angle of each v-shaped score line is preferably within the range of about 50° to about 60°. In the illustrated embodiment, the included angle of each score line is about 55°. The greater the included angle of the score line, the greater is the pressure on the back side of the blade upon scoring, and thus the greater is the likelihood that the scoring tool will create a ripple effect on the back side of the blade. The smaller the included angle, on the other hand, the more rapid will be the scoring tool wear during use.

In an alternative embodiment with reference to FIG. 11, the segmented utility knife blade may include a plurality of the notches 160 (shown in broken lines). Each notch 160 is formed at a juncture of a respective score line 128 and the cutting edge 114 of the blade to facilitate bending and snapping a respective cutting edge segment from the blade. For example, the utility knife blades may be bi-metal having high speed or tool steel cutting edges 114 defined by a cutting metal portion 228 and a relatively tough, spring-like backing 226 extending to the back edge. Notches 160 formed in the high speed or tool steel portion of the blade facilitate snapping off of a respective cutting segment of the blade by snapping off just the spring-like backing 226 extending to the back edge without having to snap the harder cutting metal portion 228.

As may be recognized by those skilled in the pertinent art based on the teachings herein, numerous changes and modifications may be made to the above described and other embodiments of the blunt tip utility knife blades of the present invention without departing from the scope of the invention as defined in the appended claims. For example, as shown in FIGS. 5 and 11, the blades may take any of numerous different shapes and/or configurations. As shown in FIGS. 5 and 11, the second side edge 52, 152 may define straight edges extending from the convex radiused edge to the back edge. Alternatively, as shown with dashed line 218 in FIG. 11, the second side edge 152 may define a convex portion. The blade 100 of FIG. 11 is designed for use in a “snap-off” blade holder of a type known to those of ordinary skill in the pertinent art whereby each substantially parallelogram-shaped segment (or other shaped segment, if desired) may be snapped off when the respective cutting edge segment 114 and/or cutting corner 120 becomes worn to, in turn, expose a fresh cutting edge segment. Similarly, although the utility knife blades 10, 100 described above define a bi-metal construction, the blades of the present invention may equally define a single metal, tri-metal or other composite or material construction. Accordingly, this detailed description of preferred embodiments is to be taken in an illustrative, as opposed to a limiting sense.

What is claimed is:

1. A utility blade comprising:
a blade body of a generally planar shape;
a cutting edge;
a back edge opposite the cutting edge;
a pair of opposing side edges, at least one first side edge of the pair of opposing side edges having a first end and a second end, the first end of the at least one first side edge extending substantially normal to the cutting edge from a terminal end defining the cutting edge; and
a convex radiused edge extending from the second end of the at least one first side edge;
wherein the convex radiused edge provides a substantially blunt profile configured to limit puncture wounds to a user while the at least one first side edge intersecting with the cutting edge provides a sharp profile for penetration through an object.

2. The blade of claim 1, wherein the convex radiused edge is defined by a radius in the range of about ⅛ inch to about ⅜ inch.

3. The blade of claim 1, wherein the convex radiused edge is defined by a radius of about ¼ inch.

4. The blade of claim 1, wherein each of the opposing side edges converges toward a blunt back edge, the blade having a uniform thickness and a tapered portion adjacent to the cutting edge which reaches a minimum thickness at the cutting edge.

5. The blade of claim 1, wherein the blade body is segmented by a plurality of axially spaced apart score lines, and the score lines extend between the cutting edge and the back edge and correspond to a profile of the at least one first side edge and the convex radiused edge.

6. The blade of claim 5, wherein the plurality of score lines define a plurality of blade sections therebetween.

7. The blade of claim 6, further comprising a plurality of notches, wherein the plurality of the notches are each formed at a juncture of a respective score line and a cutting edge of the blade to facilitate bending and snapping a respective cutting segment from the blade.

8. The blade of claim 1, further comprising;
at least one notch disposed in a central portion of the blade body, the at least one notch enabling engagement with a handle configured to receive the utility blade.

9. The blade of claim 8, wherein the at least one notch includes four serially aligned approximately D-shaped notches defining the central portion of the back edge.

10. The blade of claim 1, wherein the intersection of the at least one first side edge and the cutting edge defines a corresponding cutting corner, the cutting corner being substantially laterally aligned with a corresponding convex radiused edge.

11. The blade of claim 1, wherein the cutting edge defines a straight edge.

12. The blade of claim 1, further defining a cutting corner at each end of the cutting edge, wherein each corner is formed by a surface that is oriented approximately perpendicular to the cutting edge.

13. The blade of claim 1, wherein edges of the blade define one of an approximately trapezoidal shape, an approximately rectangular shape, and an approximately parallelogram shape.

14. The blade of claim 1, wherein at least a major portion of the blade body extending from the back edge toward the cutting edge defines a first metal portion formed of a steel heat treated to a hardness within the range of approximately 38 Rc to approximately 52 Rc, the cutting edge extending to the first metal portion defines a second metal portion formed of a tool steel heat treated to a hardness within the range of approximately 60 Rc to approximately 75 Rc, and the first and second metal portions are joined by a weld region extending between the opposing side edges of the blade.

15. A utility blade, comprising:
a trapezoidal blade body of a generally planar shape and having at least one aperture enabling engagement with a handle configured to receive the blade body,
a cutting edge;
a blunt back edge;
a pair of opposing side edges, each having a first side edge with a first end and a second end, the first end of each first side edge extending substantially normal to the cutting edge at opposing terminal ends defining the cutting edge; and
a pair of opposing convex radiused edges, each extending from the second end of a respective first side edge and defined by a radius within the range of about ⅛ inch to about ⅜ inch;
wherein the intersection of each first side edge and the cutting edge defines a respective substantially right angle cutting corner, each cutting corner is substantially laterally aligned with a corresponding convex radiused edge, each convex radiused edge provides a substantially blunt profile configured to limit puncture wounds to a user, and the corresponding cutting corner provides a sharp profile to facilitate penetration through an object.

16. A utility knife, comprising:
a blade body of a generally planar shape, the blade body comprising:
a cutting edge;
a pair of opposing side edges, at least one first side edge of the pair of opposing side edges having a first end and a second end, the first end of the at least one first side edge extending substantially normal to the cutting edge from a terminal end defining the cutting edge; and
a convex radiused edge extending from the second end of the at least one first side edge; and
a handle configured to receive the blade body, wherein the at least one first side edge and at least a portion of said cutting edge are exposed during use, the convex radiused edge provides a substantially blunt profile configured to limit puncture wounds to a user, and the at least one first side edge intersecting with the cutting edge provides a sharp profile for penetrating an object.

17. The utility knife of claim 16, wherein the blade body is segmented by a plurality of axially spaced apart score lines, and the score lines extend between the cutting edge and an opposite back edge and correspond to a profile of the at least one first side edge and the convex radiused edge.

18. The blade of claim 17, wherein the plurality of score lines define a plurality of blade sections therebetween.

19. The blade of claim 18, further comprising a plurality of notches, wherein the plurality of the notches are each formed at a juncture of a respective score line and a cutting edge of the blade to facilitate bending and snapping a respective cutting segment from the blade.
